(19) United States
(12) Patent Application Publication
(10) Pub. No.: US 2015/0156168 A1
(43) Pub. Date: Jun. 4, 2015

(54) SUGGESTING NAME IDENTIFIERS USING INTERACTIVE KEYWORDS

(71) Applicant: Go Daddy Operating Company, LLC, Scottsdale, AZ (US)

(72) Inventors: Michael J. McLaughlin, Menlo Park, CA (US); Tapan Kamdar, San Jose, CA (US)

(21) Appl. No.: 14/097,022

(22) Filed: Dec. 4, 2013

(51) Int. Cl. H04L 29/12; G06F 3/0482; G06F 17/30

(52) U.S. Cl. CPC H04L 61/3025; G06F 17/3064; G06F 3/0482

(57) ABSTRACT

A method for creating, displaying, and registering name identifiers, such as domain names or social media handles, using interactive tokens and keywords is presented. A user may enter a user search into a data entry field on a webpage of a website. The user search may be tokenized, with each token representing an entity or word in the user search. A plurality of keywords, typically synonyms or related words, are found for one or more of the tokens. The tokens and keywords are displayed on a webpage along with methods for selecting tokens and/or keywords to be used to spin a batch of name identifiers. The user may add, delete, edit, reorder, and/or lock tokens and select keywords. The tokens and/or selected keywords, along with selected or determined domain name extensions, are combined to create a plurality of name identifiers. The user may select one or more of the name identifiers for registration.

### FIELD OF THE INVENTION

The present invention generally relates to the field of suggesting name identifiers and, as a specific example, to the field of domain name spinning using interactive tokens and keywords.

### SUMMARY OF THE INVENTION

The present invention provides methods for spinning name identifiers, such as domain names, using interactive tokens and keywords. An exemplary method may start with a name identifier registering entity, such as, as non-limiting examples, a social media platform, a domain name reseller, Registrar, or Registry, receiving a user search from a user. The user search may be entered in a data entry field on a webpage of a website, generated using information associated with the user found on the Internet or in one or more proprietary databases, or generated from a keyword spinner. The user search may be a domain name or a plurality of words (with our without spaces) and may be parsed into one or more words.

Adjacent or neighboring words may be analyzed to determine if there are any entities, such as, as a non-limiting example, n-grams, in the one or more words. Entities or words that have not been found to be helpful in the past may also be dropped from consideration. In addition, words that are prepositions, pronouns, articles, or that have been found in past to be unhelpful, may be dropped from consideration. The remaining entities and words may be tokenized, i.e. each entity and/or remaining word may be assigned to represent a token. While any number of tokens may be found and used, it is preferable, simply for display and practical reasons (for example, longer domain names or social media handles are generally less desirable than shorter ones), to limit the number of tokens to two, three, four, or five.

Zero or more keywords may be found for each token. The keywords may be synonyms, words related or often associated with one of the tokens, commonly purchased together, and/or experimental words. Each token and its plurality of keywords may be displayed, preferably in a vertical list, on a webpage to the user. Thus, for example, if three tokens are selected, there would be three lists. There are preferably check boxes, data entry fields, menus, tag clouds, or other ways on the webpage to allow the user to select zero or more keywords from each list.

The user may be given the capability to add, delete, edit, reorder, and/or lock tokens. The webpage preferably automatically updates to reflect the user's manipulation of the tokens, e.g. newly added tokens are shown (with corresponding keywords), while deleted tokens (and their keywords) are no longer shown on the webpage.

The user may select zero or more keywords at any time during the process. When the user has finished manipulating the tokens and selected the desired keywords, the user may indicate that the user is ready to spin, i.e. create a new batch of name identifiers, such as domain names or social media handles (names).

Domain names may be created by combining various tokens from a set of keywords and a domain name extension. In a preferred embodiment, only zero or one token or selected keyword from each list is combined with a single domain name extension. Limiting only zero or one token or selected keyword from each list reduces the chance of having synonyms in the same suggested domain name which might unnecessarily increase the length of a suggested domain name.

The name identifiers, such as domain names, are preferably prioritized, or a methodology used, so that the name identifiers that are mostly likely to be chosen have a higher priority than name identifiers that are less likely to be chosen. If the number of name identifiers exceeds a predetermined number, the lower priority name identifiers may be dropped from consideration.

The remaining created name identifiers may be checked for availability. Name identifiers that are available may be displayed on a webpage designed for this purpose, preferably with the highest priority name identifiers in the most prominent positions.

The user may select zero or more name identifiers for registration, in which case the selected name identifiers may be registered to the use. As a specific, non-limiting example, selected domain names may be registered with a Registry. Alternatively, or in addition, the user may enter a new user search or add, delete, edit, reorder, and/or lock one or more tokens to cause a new batch of name identifiers to be displayed on a webpage that may be selected for registration.

The above features and advantages of the present invention will be better understood from the following detailed description taken in conjunction with the accompanying drawings.

### BRIEF DESCRIPTION OF THE DRAWINGS

FIG. 1 is a block diagram of a system that may be used to practice the present invention.

FIG. 2 illustrates a portion of a webpage of a website for allowing a user to enter a user search into a data entry field.

FIG. 3 illustrates possible tokens that may be created from an example user search.

FIG. 4 illustrates a portion of a webpage displaying a plurality of lists, wherein each list comprises a token and keywords related to the token.

FIG. 5 illustrates a portion of a webpage displaying a plurality of lists, wherein each list comprises a token and keywords related to the token.

FIG. 6 illustrates a portion of a webpage displaying a plurality of lists, wherein each list comprises a token and keywords related to the token.

FIG. 7 illustrates a portion of a webpage displaying a plurality of lists, wherein each list comprises a token and keywords related to the token.

FIG. 8 illustrates a portion of a webpage displaying a plurality of lists, wherein each list comprises a token and keywords related to the token.

FIG. 9 illustrates a portion of a webpage displaying a plurality of available domain names created based on the tokens and selected keywords.

FIG. 10 is a first part of a flow diagram illustrating an example embodiment of a method for domain name spinning using interactive keywords.

FIG. 11 is a second part of a flow diagram illustrating an example embodiment of a method for domain name spinning using interactive keywords.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

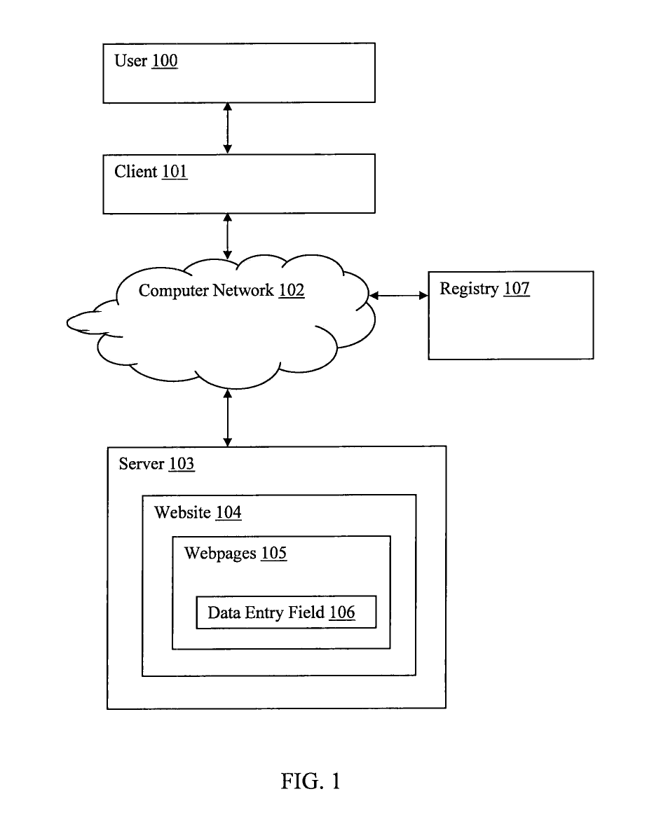

FIG. 1 is a block diagram of a system that may be used to practice the present invention. A computer network 102 is a collection of links and nodes (e.g., multiple computers and/or other devices connected together) arranged so that information may be passed from one part of the computer network 102 to another over multiple links and through various nodes. Examples of computer networks 102 include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users 100 on clients 101. Hundreds of millions of people around the world have access to computers (clients 101) connected to the Internet via Internet Service Providers (ISPs). Content providers place multimedia information (e.g., text, graphics, audio, video, animation, and other forms of data) at specific locations on the Internet referred to as websites 104. The combination of all the websites and their corresponding web pages on the Internet is generally known as the World Wide Web (WWW) or simply the Web.

For Internet users 100 and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other.

Prevalent on the Web are multimedia websites 104, some of which may offer and sell goods and services to individuals and organizations. Websites 104 may consist of a single webpage 105, but typically consist of multiple interconnected and related webpages 105. Websites 104, unless very large and complex or have unusual traffic demands, typically reside on a single server 103 and are prepared and maintained by a single individual or entity (although websites 104 residing on multiple servers 103 is certainly possible). Menus, links, tabs, etc. may be used to move between different web pages 105 within the website 104 or to move to a different website.

Websites 104 may be created using HyperText Markup Language (HTML) to generate a standard set of tags that define how the webpages 105 for the website 104 are to be displayed. Users 100 of the Internet may access content providers' websites 104 using software known as an Internet browser, such as MICROSOFT INTERNET EXPLORER or MOZILLA FIREFOX. After the browser has located the desired webpage 105, it requests and receives information from the webpage, typically in the form of an HTML document, and then displays the webpage content for the user 100 on the client 101. The user 100 then may view other webpages 105 at the same website 104 or move to an entirely different website using the browser.

Some Internet users, typically those that are larger and more sophisticated, may provide their own hardware, software, and connections to the Internet. But many Internet users either do not have the resources available or do not want to create and maintain the infrastructure necessary to host their own websites. To assist such individuals (or entities), hosting companies exist that offer website hosting services. These hosting providers typically provide the hardware, software, and electronic communication means necessary to connect multiple websites to the Internet. A single hosting provider may literally host thousands of websites on one or more hosting servers 103.

Browsers are able to locate specific websites 104 because each website 104, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the Registry 107 is also the authoritative source for contact information related to the domain name and is referred to as a “thick” Registry 107. For other TLDs (e.g., .com and .net) only the domain name, registrar identification, and name server information is stored within the Registry 107, and a Registrar is the authoritative source for the contact information related to the domain name. Such Registries 107 are referred to as “thin” registries 107. Most gTLDs are organized through a central domain name Shared Registration System (SRS) based on their TLD. TLDs may also be referred to as domain name extensions.

The process for registering a domain name with .com, .net, .org, and some other TLDs allows an Internet user 100 to use an ICANN-accredited Registrar to register their domain name. For example, if an Internet user, John Doe, wishes to register the domain name “mycompany.com,” John Doe may initially determine whether the desired domain name is available by contacting a domain name registrar. The Internet user 100 may make this contact using the Registrar's webpage and typing the desired domain name into a field on the registrar's webpage created for this purpose. Upon receiving the request from the Internet user 100, the Registrar may ascertain whether “mycompany.com” has already been registered by checking the SRS database associated with the TLD of the domain name or by checking with the Registry. The results of the search then may be displayed on the webpage to thereby notify the Internet user 100 of the availability of the domain name. If the domain name is available, the Internet user 100 may proceed with the registration process. If the domain name is not available for registration, the Internet user 100 may keep selecting alternative domain names until an available domain name is found.

A current problem many Internet users 100 face is trying to find a domain name that is available. A similar problem exists in trying to find a handle or name with a social media platform. It is generally desirable to have a domain name (or social media handle) that is as generic and short as possible. A generic domain name makes a website easier to find, thereby increasing its traffic, while shorter domain names are easier to remember and enter into a browser. Unfortunately, many people want the same short generic domain names making it difficult for new Internet users to find a good domain name that is not already registered. The present invention addresses the problem of finding a good available domain name or social media handle.

A user 100 will typically be a person trying to register one or more domain names or a social media handle. The user 100 may use a client 101, such as, as non-limiting examples, a cell phone, PDA, tablet, laptop computer, or desktop computer to access a website 104 via a computer network 102, such as the Internet.

The website 104 may have a plurality of webpages 105. The website 104 may be hosted or operated from a server 103. The server 103 may be, as a non-limiting example, one or more Dell PowerEdge(s) rack server(s) although other types of servers, combinations of one or more servers, server software and applications may be used. The webpages 105 may have one or more display fields as well as one or more data entry fields 106. The data entry fields 106 allow the user 100 to enter data into the website 104 from a client 101.

One or more Registries 107 may be connected to the computer network 102, which is preferably the Internet, so that the Registries' 107 functions may be easily accessed by electronic commands. While any number of different functions from the Registry 107 may be used, the present invention is primarily concerned with using the Registry 107 to determine if one or more domain names are available for registration and registering one or more domain names to the user 100. A similar process may be used for social media platforms instead of domain name Registries 107.

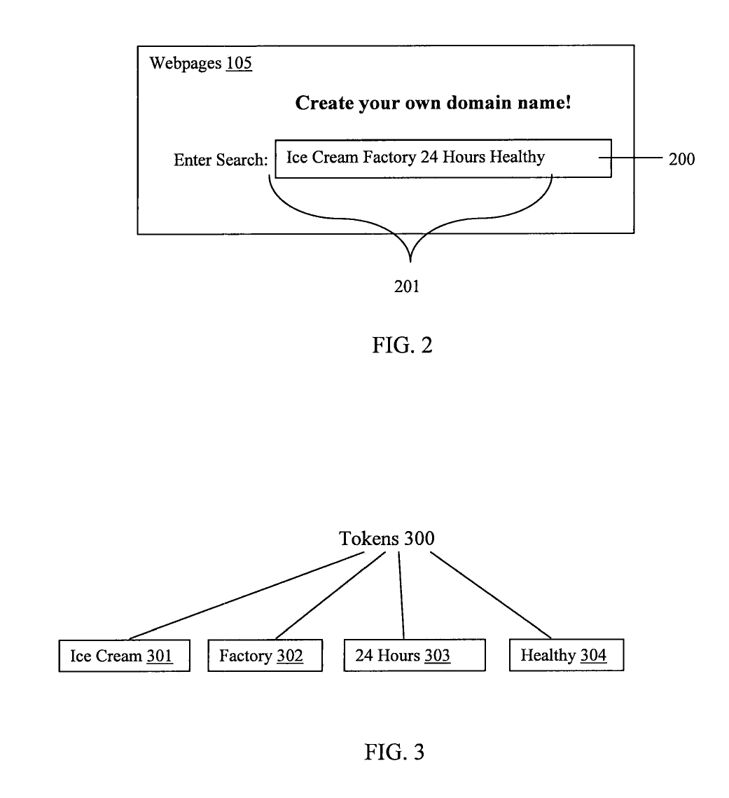

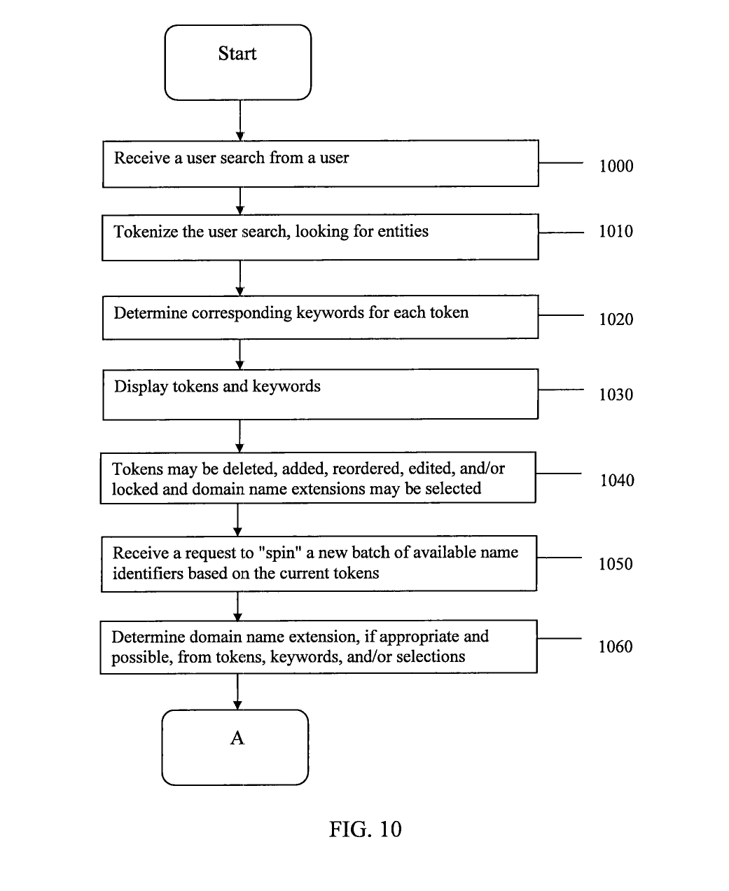

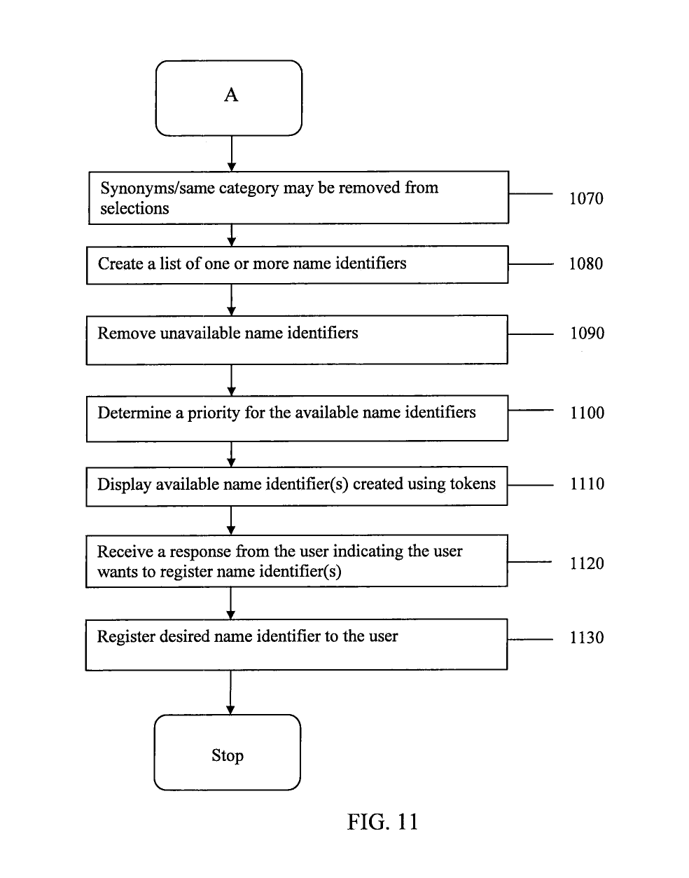

An exemplary process for practicing the invention is illustrated in FIGS. 10 and 11. A user 100 may enter a user search 201 into a data entry field 200 on a webpage 105 of a website 104 as illustrated in FIG. 2. (Step 1000) In FIG. 2, the user 100 has entered a user search 201 of “Ice Cream Factory 24 Hours Healthy” from the user's client 101. The user 100 may enter any number of different character strings that may be received and analyzed as a user search 201, by a server 103, with the current invention.

The server 103 tokenizes the user search 201 into one or more tokens 300. The user search 201 may be a domain name, string of characters, a string of words, and/or some combination thereof. The tokenization process preferably begins by parsing the user search 201 into a plurality of words or character strings. In the example from FIG. 2, the words and character strings found may be “Ice,” “Cream,” “Factory,” “24,” “Hours,” and “Healthy.” Domain names are not case sensitive, thus either capital or non-capital letters may be used for the words, entities, and/or tokens depending on visual preference.

In another embodiment, the user 100 does not have to enter a user search 201 for a plurality of tokens 300 to be generated and displayed. As an example, information may be found, preferably online or in one or more proprietary databases, that is associated with the user 100 and this information may be used to generate a plurality of tokens 300 associated with the user 100. As another option, a keyword spinner may be used to generate a plurality of tokens 300 using any known, or later developed, method of spinning words. As non-limiting examples, the user search 201 and/or tokens 300 may be generated and displayed by combining various subcombinations and combinations of words associated with the user 100, random words, words that have been selected in the past by the same or different users 100, the user's name, address or location, associated businesses' names, past purchases, social media handles or data, data from proprietary databases, hobbies, or any other online personal, recreational, business, and/or professional information.

Adjacent or neighboring words and character strings in the user search 201 may be examined to determine how often the words appear next to each other in general use. This may be accomplished by searching for the word combinations in one or more online or proprietary databases. Groups of words and character strings that appear next to each other frequently may be consider an entity and be assigned to a single token 300. In the current example, the entity “Ice Cream” and “24 Hours” may be discovered. The tokens 300 may remain “Ice,” “Cream,” “24,” and “Hours,” but are preferably reformatted to “Ice Cream” 301 and “24 Hours” 303.

Prepositions, pronouns, articles, stop words, etc. (that are not part of an entity) may be removed from consideration. The remaining words (“Factory” and “Healthy”) and entities (“Ice Cream” and “24 Hours”) may be considered tokens and prioritized. The prioritization may be based, as non-limiting examples, on how often the words or entities have been selected for domain name registration in the past or by the order the words and entities were entered into the data entry field, i.e. from left to right.

While any number of tokens 300 may be used, in a preferred embodiment only four tokens or less, having the highest priority, are used. Thus, as shown in FIG. 3, the tokens in the current example, prioritized in the order the words were entered into the data entry field 200, are “Ice Cream” 301, “Factory” 302, “24 Hours” 303, and “Healthy” 304. (Step 1010)

For each token 300, zero or more corresponding keywords 400 may be found. The keywords 400 may be, as non-limiting examples, synonyms, related words, commonly purchased together words, experimental words, associated in a database, determined by analysis of domain name search logs, determined to have grammatical similarities, i.e. parts of speech, associations through search engines, thesauruses, and/or found using synonym generators with one of the tokens 300. (Step 1020)

In one embodiment for selecting keywords 400, previous domain name search logs may be analyzed. For example, if domain names containing “Ice Cream” were unavailable and past users consistently selected alternative domain names containing “Gelato,” then “Gelato” would preferably be made one of the keywords 400 associated with the token “Ice Cream.”

The keywords 400 are preferably prioritized and listed in their order of priority under each token with the highest priority keywords 400 being placed at the top of the list. Higher priority keywords 400 may be made a different color, font, size, bold, etc. or placed in a tag cloud to encourage the selection of the higher priority keywords 400. The keywords 400 may be ranked, as non-limiting examples, based on the number of users that have selected the keyword 400 in the past, past domain name selections and/or domain names registered that contain the keyword 400. This criteria can be further broken down, for example, by prioritizing keywords 400 in registered domain names above keywords in domain names only selected for registration, but where the user 100 never finished the registration process for the domain name. In another embodiment, the keywords may be presented in a tag cloud, near their associated token, for selection, with higher priority keywords larger or made more prominent than lower priority keywords.

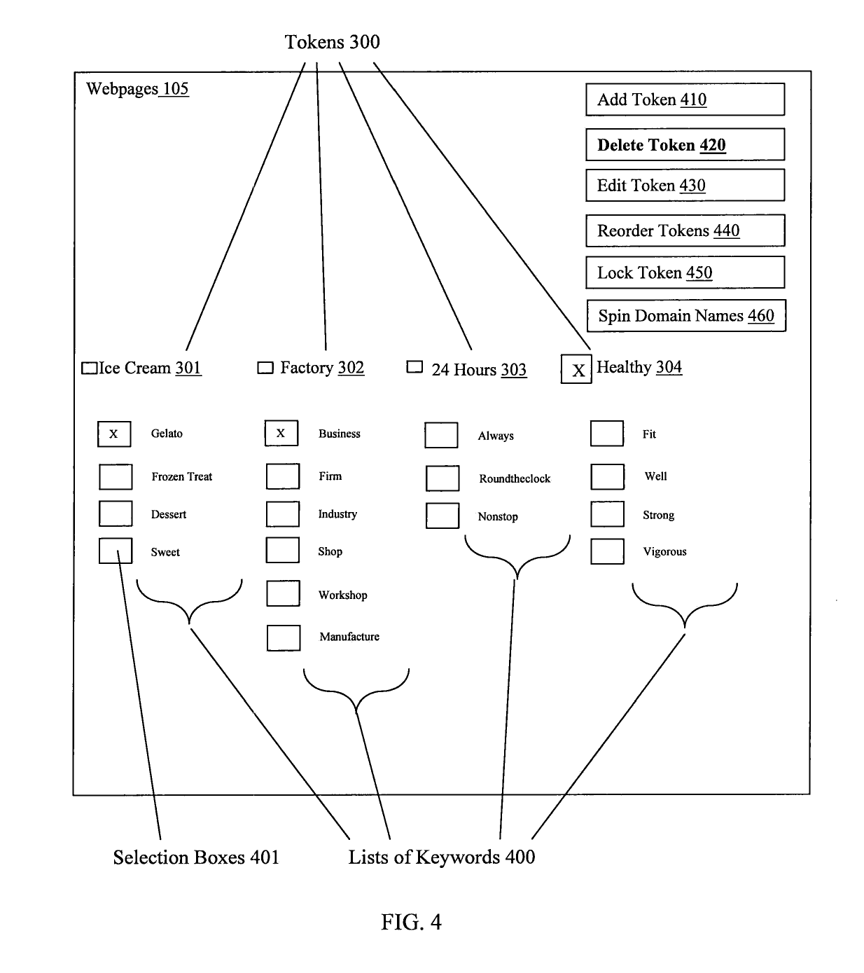

The tokens 300 and keywords 400 may be arranged in lists, with each token and the token's associated keywords 400 forming a list, and displayed on a webpage 105 as shown in FIG. 4. The lists are preferably arranged in order of priority, as previously determined, with the highest priority token 300 farthest to the left and the lowest priority token 300 farthest to the right on the webpage 105. In the illustrated example, the tokens 300 “Ice Cream” 301, “Factory” 302, “24 Hours” 303, and “Healthy” 304 are arranged in that order, from left to right, as that was the order of priority the tokens 300 received based on the order the tokens 300 were entered into the data entry field 200 by the user 100.

While not shown in the embodiment illustrated in FIG. 4, a list, preferably on the right side of all the tokens 300, may be displayed showing domain name extensions or TLDs. In this embodiment, the user 100 may select one or more domain name extensions to use in spinning domain names. Alternatively, the domain name extensions may also be selected based on the user search 201, selected keywords 400 and/or tokens 300.

The user 100 may decide to add another token 300, delete a token 300, edit a token 300, reorder tokens 300, lock a token 300, select zero or more keywords from each displayed list, select zero or more domain name extensions, and/or decide to spin a new batch of available domain names (or social media handles) based on the currently displayed tokens 300. (Step 1040) Any of these actions may be taken without the user 100 having to reenter the user search 201, thereby greatly simplifying the process of spinning domain names for the user 100 since the user 100 only has to enter the user search 201 one time (although the user 100 could enter a new user search if the user 100 so desired.)

While specific buttons (“Add Token” 410, “Delete Token” 420, “Edit Token” 430, “Reorder Tokens” 440, “Lock Token” 450, and “Spin Domain Names” 460) are displayed on the webpage 105 in FIG. 4, it should be understood that any known, or developed in the future, method may be used to allow the user 100 to indicate the user's 100 desires, such as to manipulate the tokens 300 or perform various functions on the webpage 105. As non-limiting examples, fixed menus, pull-down menus, radio buttons, tabs, bars, left or right mouse clicks, pulling or dragging icons, text entry boxes, check boxes, soft buttons, touch screens, voice activation or commands, and/or any other method for manipulating the tokens or initiating an action may be used by the user 100.

Delete a Token

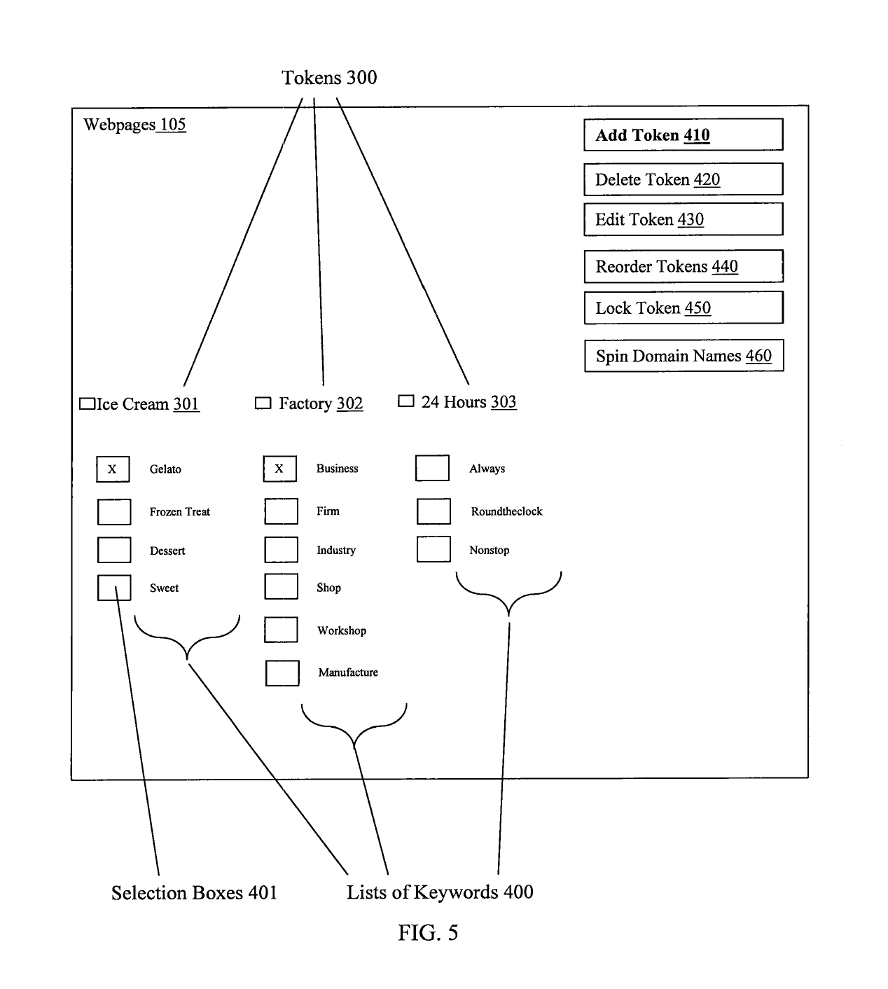

The user 100 may decide to delete one of the active and displayed tokens 300. For example, the user 100 may decide to delete, i.e., not use, the token 300 “Healthy” 304 in spinning new domain names (or social media handles). In such a situation, the user 100 may provide an indication that the user 100 desires to delete one of the tokens 300. As one possible non-limiting mechanism for deleting a token 300, the user 100 may place a check in a box in front of the token 300 desired to be deleted (in this case “Healthy” 304) and select the “Delete Token” 420 button. As another non-limiting example, the text “Health” 304 may be dragged to a trash can icon (not shown) using a mouse, stylus, or touch screen. As another non-limiting example, the text “Health” 304 may be right clicked on causing a menu to appear that includes the option to delete the token 300. After deleting the token “Health” 304, the webpage 105 may be automatically updated by the server 103 to reflect that the token 300 “Healthy” 304 is no longer active, i.e. the token “Healthy” 304 and its associated keywords 400 may be removed from the webpage 105. FIG. 5 illustrates the webpage 105 after the token 300 “Healthy” 304 has been deleted.

Add a Token

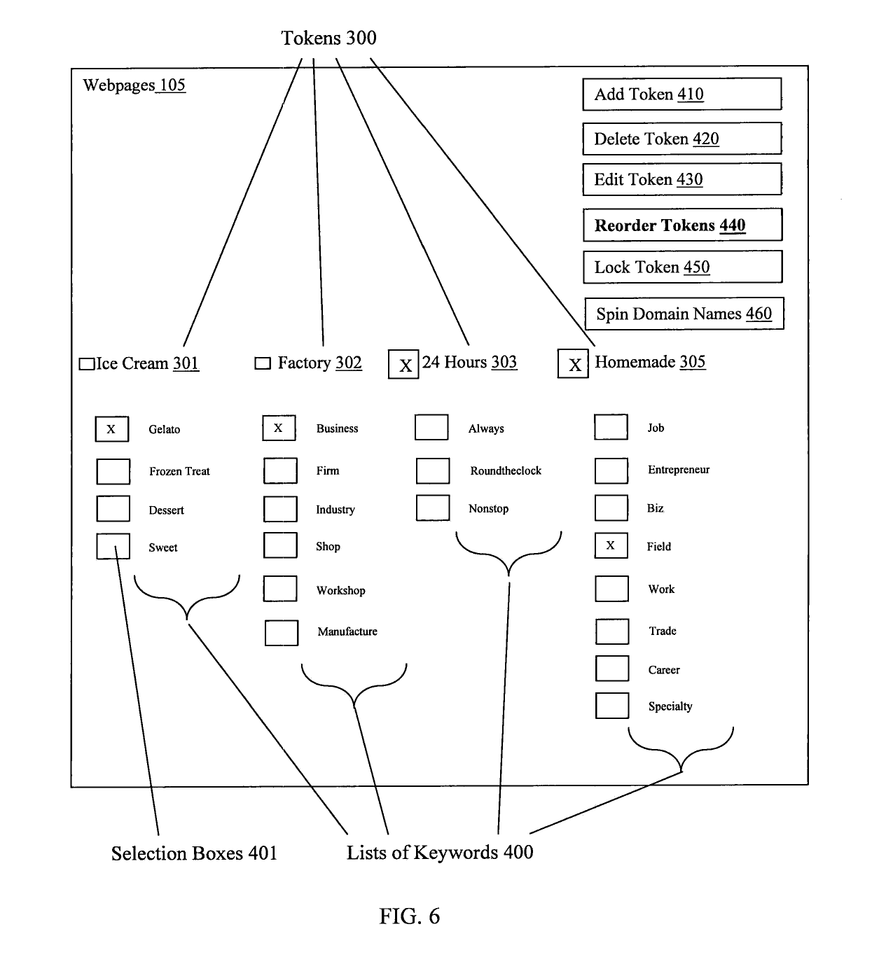

The user 100 may decide to add a new token and, optionally, the order of the new token 300 in relation to the existing tokens 300. For example, the user 100 may decide to add the token 300 “Homemade” 305 to the end of the list of tokens 300 illustrated in FIG. 5. The user 100 may provide an indication that the user 100 desires to add the new token 300 using any known, or later discovered, method in the art. As non-limiting examples, the new token may be verbally entered, the user 100 may click on a position at the start, end, or in between tokens and enter the new token, or the user 100 may select the “Add Token” 410 button and enter a token 300 in a data entry field created for this purpose. As a specific example, the user 100 may enter “Homemade” 305 in a data entry field. The webpage 105 may be automatically updated to reflect that a new token “Homemade” 305 has been added. FIG. 6 illustrates the webpage 105 after the token 300 “Homemade” 305 has been added to the right of the other active tokens 300, although, in a preferred embodiment, the new token may be added to any position of the tokens 300.

Reorder Tokens

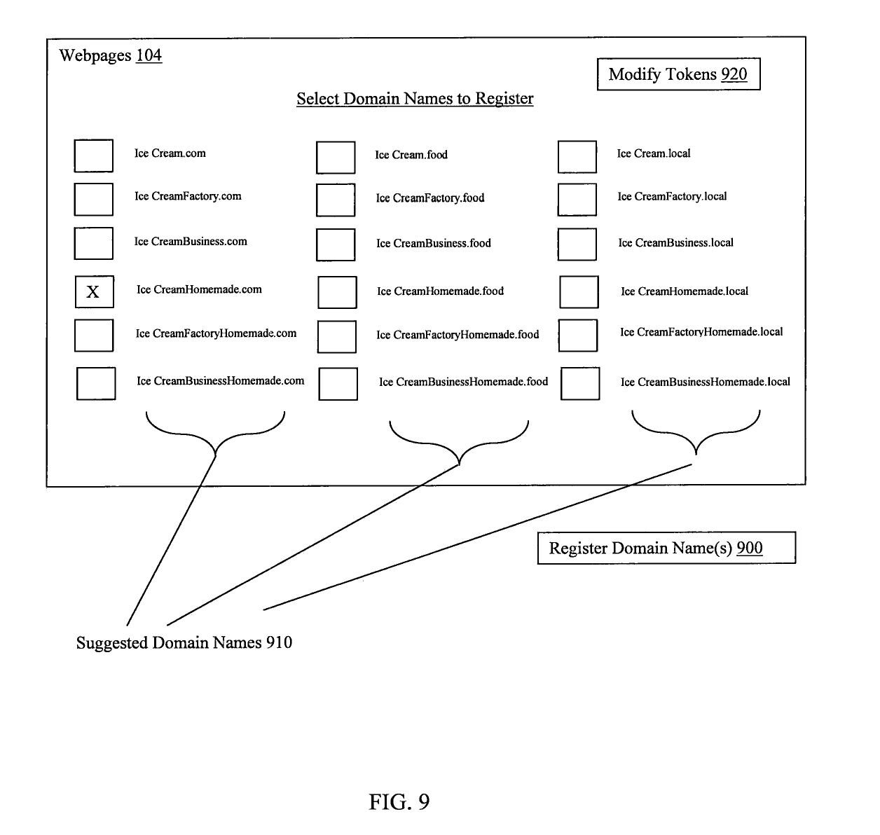

The user 100 may decide to reorder the tokens 300, which also has the effect of reordering the lists of keywords. For some embodiments, the ability to reorder tokens is important since the created suggested domain names, shown in FIG. 9, are preferably created by concatenating selections from the lists from left to right. This means, in certain embodiments, tokens or keywords that appear to the left on webpage 105 will be to the left of tokens or keywords that appear to the right on webpage 105 in all suggested domain names (or social media handles). This embodiment allows the user 100 to control the order of the tokens 300 and selected keywords 400 as they appear in the created and suggested domain names (or social media handles).

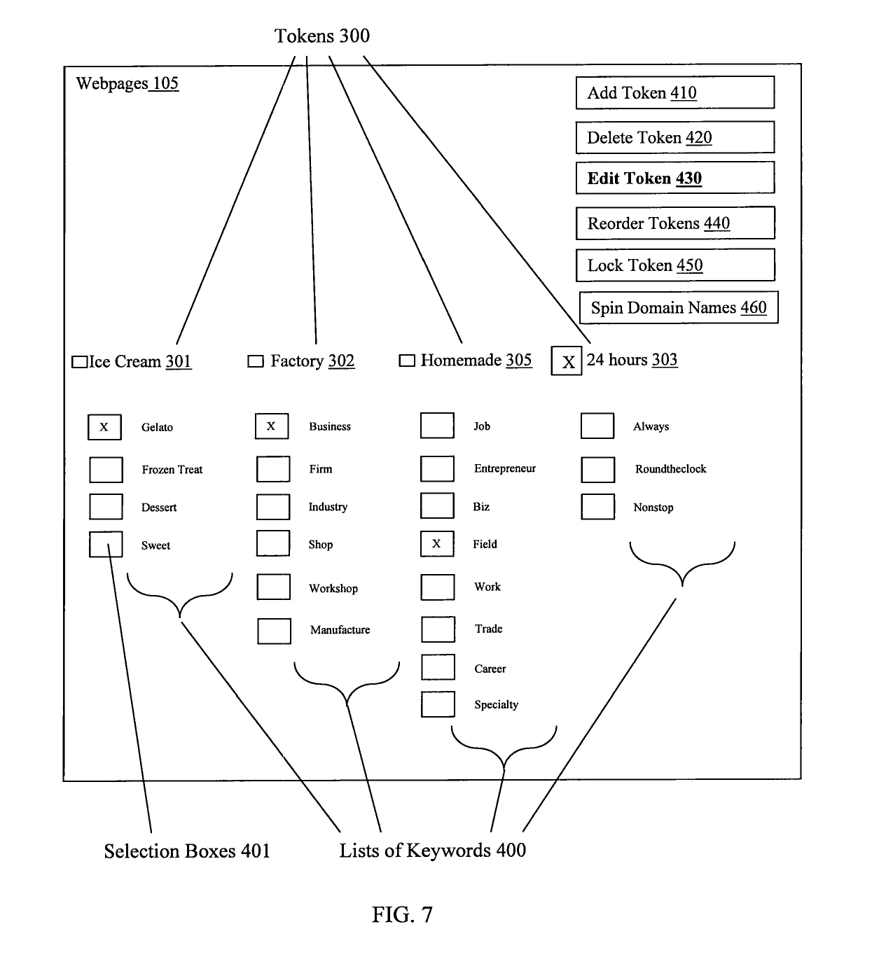

The user 100 may provide an indication that the user 100 desires to reorder one or more tokens 300 (and thus the tokens' 300 associated keywords 400) using any known, or later developed, method. As one non-limiting example, the user may drag and drop a token 300 into a new position (such as between two other existing tokens 300). In another non-limiting example, the user 100 may place a check mark in front of boxes in front of tokens 300 that are desired to be reordered. This is illustrated in FIG. 6. A check has been placed in front of “24 Hours” 303 and in front of “Homemade” 305. The user 100 may then select the “Reorder Tokens” 440 button to cause the two tokens to be reordered (switched in this example) as illustrated in FIG. 7.

Edit Token

The user 100 may decide to edit one of the tokens 300. The user 100 may provide an indication that the user 100 desires to edit a token using any known, or later developed, method. As one non-limiting example, the user may click on the token desired to be edited and edit the text of the token. The edited token may differ from the original token by a single character, the edited token may be an entirely different word or entity, or anything in between. Preferably, the editing process is similar to that performed in word processing applications.

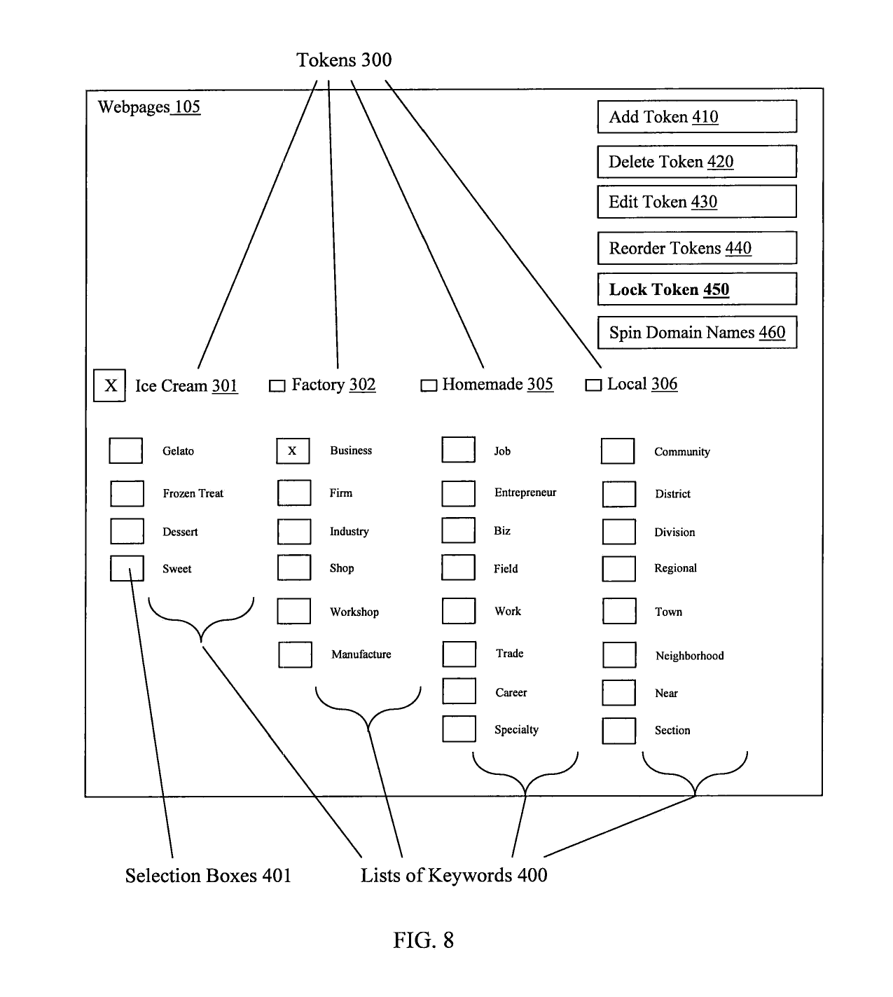

After receiving the edited token, zero or more corresponding keywords 400 may be found. The keywords may be, as non-limiting examples, synonyms, categorically related, associated in a database, determined by analysis of domain name search logs, determined to have grammatical similarities, i.e. parts of speech, associations through search engines, thesauruses, and/or found using synonym generators with the edited token. A new list may be created for the edited token and its corresponding keywords. This new list with the edited token and new corresponding keywords may be automatically displayed on the webpage 105, while the list of the token before it was edited is preferably deleted and no longer displayed on the webpage 105. FIG. 8 shows a possible result after the token “24 Hours” 303 was edited to be “Local” 306 from FIG. 7.

Lock Token

The user 100 may decide to lock one or more of the tokens 300. This option allows the user 100 to be sure that every suggested domain name or social media handle will include the locked token(s) 300. The user 100 may provide an indication that the user 100 desires to lock a token 300 using any known or later developed method of entering data into a webpage 105. As one non-limiting example, FIG. 8 illustrates how the user 100 may place a check mark in front of a token 300 (in this example “Ice Cream” 301) and then selects a “Lock Token” 450 button. As another non-limiting example, there may be a box or selection feature for each token that may be selected to indicate that one or more of the tokens is locked. Optionally, locked tokens may be marked, such as by changing the color of their text, size of their font, using bold text, or by other visual methods.

Select Keywords

The user 100 may select zero or more keywords from each token's list of keywords using any known, or latter developed, method. The keywords 400 may be concatenated together with tokens and/or keywords from other lists in subcombinations and combinations to form suggested domain names or social media handles during the spinning process. A limit may be placed on the number of keywords 400 that the user 100 may select from each list to prevent the number of possible name identifiers (permutations) to become too burdensome to create and verify availability.

Select Domain Name Extension(s)

The user 100 may also have the option of selecting one or more domain name extensions in a manner similar to that used to select tokens 300 and keywords 400. This allows the user 100 to be sure that every suggested domain name will have one of the user's 100 selected domain name extensions. In another embodiment, the system may determine, based on the tokens, selected keywords, historical data, purchase logs, online information, proprietary databases, user location, etc. which domain name extensions should be used for the suggested domain names. (Step 1060) As an example, the created domain names in FIG. 9 assume that the domain name extensions “.com,” “.food,” and “.local” where selected by the user or determined by the server 103.

Spin Name Identifiers

The user 100 may provide an indication, using any known, or developed in the future, method that the user 100 wishes to view one or more available name identifiers (such as, as non-limiting examples, domain names or social media handles) based on subcombinations and combinations of the selected tokens 300 and keywords 400. The user 100 may spin, i.e. create a new batch of domain names, preferably after the user 100 has the desired tokens, in the desired order, selected the desired keywords, and/or locked the desired tokens/keywords as many times as desired. As one non-limiting example, the user 100 may select a “Spin Domain Names” 460 button when ready to spin for more domain names. (Step 1050)

A plurality of name identifiers, such as domain names or social media handles, may be created by concatenating various subcombinations and combinations of the tokens 300, the selected keywords 400, and/or the selected or determined domain name extensions. (Step 1080)

In a preferred embodiment, only one token 300 or keyword 400 from each list is used in a single domain name or social media handle. This helps prevent two or more synonyms appearing in the same name identifier. Another option is to allow only one synonym (even if the synonyms appear from different token lists) in the same name identifier. This option can include considering domain name extensions in the synonym analysis, i.e. a token or keyword that is a synonym of a domain name extension would not be used in the same domain name with the domain name extension. (Step 1070) The non-used synonym token(s), keyword(s), and/or domain name extension(s) may still be used in different domain names, just not together in the same domain name or social media handle.

Control Order of Tokens in Suggested Name Identifiers

Another option is to retain the order of the tokens 300 and keywords 400 in the created domain names or social media handles. As an example, the order of the tokens 300 in FIG. 8, from left to right, is “Ice Cream” 301, “Factory” 302, “Homemade” 305, and “Local” 306. Thus, the token “Ice Cream” 301 would never appear to the right in a suggested name identifier of the tokens “Factory” 302, “Homemade” 305, or “Local” 306 while “Factory” 302 would never appear to the right in a suggested name identifier of the tokens “Homemade” 305 or “Local” 306. This left to right ordering would apply to all the tokens 300 and selected keywords 400. This embodiment allows the user 100 a great deal of control over the order of the tokens 300 and keywords 400 in the suggested name identifiers 910.

Check Availability of Name Identifiers Before Displaying

After the plurality of name identifiers has been created, each name identifier may be checked, such as by checking with the Registry 107 or social media platform, comparing the name identifier against recent zone files, or by other known, or developed in the future, methods to see if each name identifier is available for registration. Unavailable name identifiers may be removed from the plurality of created name identifiers since these name identifiers would only obscure the presence of available name identifiers and confuse the user 100. (Step 1090)

The created available name identifiers 910 may be prioritized. Names identifiers 910 that are thought to be more valuable or higher quality (generally shorter and more general domain names or social media handles) may be displayed more prominently, such as at the beginning of a list. The name identifiers 910 may also be prioritized based on the order of the tokens 300 and keywords 400, with tokens 300 and keywords 400 to the left having a higher priority than tokens 300 or keywords 400 to the right. (Step 1100)

The created available name identifiers 910 (in this case domain names) may be displayed as shown on webpage 104 in FIG. 9. In this example, the domain name extensions “.com,” “.food,” and “.local” have been selected. The domain names 910 in FIG. 9 are shown for illustrative purposes and have not actually been checked for availability like the domain names would be in a preferred embodiment. (Step 1110)

The user 100 may indicate on the webpage 104 that the user desires to register zero or more of the displayed name indicators 910. In FIG. 9, each displayed domain name is provided a check box, but any known, or later discovered, method for selecting items in one or more lists may be used by the user 100 to select zero or more name identifiers 910. (Step 1120) The user 100 may also return to a webpage 105 that allows further modifications of the tokens 300 and keywords 400 by any known, or developed in the future, method of moving between webpages 105 of a website 104. As an example, the user 100 may select the “Modify Token” 920 button to return to a webpage 105 that allows the user 100 to make further modifications to the tokens 300 and keywords 400.

If the user 100 has indicated that the user 100 would like to register one or more of the domain names 910, the selected domain names may be register to the user 100 over the computer network 102 with a Registry 107. (Step 1130) In the non-limiting example provided in FIG. 9, the user may select a domain name by placing an X in the box next to the domain name and then selecting the “Register Domain Name(s) 900 button. In the example, the domain name “Ice CreamHomemade.com” is selected, but any number of different domain names may be selected using this method. The additional steps in registering the selected domain name(s) with a Registry 107 are well known (such as getting the contact and payment information of the user 100) and will not be discussed to avoid obscuring the invention with these well known processes. A similar process may be used to register a social media handle with a social media platform.

Whether or not the user 100 registers one or more name identifiers 910, the user 100 may return to the webpage 105 shown in FIG. 8 to make further modifications to the tokens 300 and the selected keywords 400. This allows the user 100 to easily create and see, i.e. spin, many more available name identifiers merely by making adjustments to the selected tokens 300 and keywords 400. This process has the advantage over previous methods by removing the step of forcing the user 100 to reenter the user search 201 prior to every name identifier search. This powerful process allows the user 100 to easily zero-in on the best possible name identifier for the user 100.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention. As examples, while the invention has been described in detail for spinning domain names, the invention may also be used to spin name identifiers in other fields. As specific non-limiting examples, the invention may also be used to spin name identifiers for license plates, phone numbers and social media name identifiers.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method, comprising the steps of:
a) presenting, by a server computer, a plurality of tokens associated with a user on a client;
b) enabling, by the server computer, the user to manipulate the plurality of tokens from the client;
c) creating, by the server computer, a plurality of name identifiers, by concatenating one or more of the plurality of tokens;
d) presenting, by the server computer, the plurality of name identifiers to the user on the client; and
e) enabling, by the server computer, the user to select at least one of the plurality of name identifiers from the client.

2. The method of claim 1, wherein the plurality of tokens are generated from a user search entered by the user.

3. The method of claim 1, wherein the plurality of tokens are generated from an information that is associated with the user.

4. The method of claim 1, wherein the plurality of tokens are generated by a keyword spinner.

5. The method of claim 1, wherein the plurality of name identifiers comprises a plurality of domain names.

6. The method of claim 1, wherein step b) further comprises the step of reordering a first token and a second token in the plurality of tokens.

7. The method of claim 1, wherein step b) further comprises the step of locking a first token in the plurality of tokens, wherein the first token appears in every name identifier in the plurality of name identifiers.

8. A method, comprising the steps of:
a) receiving, by a server computer, a user search from a user on a client, wherein the user search comprises a plurality of tokens;
b) enabling, by the server computer, the user to manipulate the plurality of tokens from the client;
c) creating, by the server computer, a plurality of domain names by concatenating one or more of the plurality of tokens with a domain name extension; and
d) enabling, by the server computer, the user to register one or more of the plurality of domain names, from the client, with an appropriate domain name registry.

9. The method of claim 8, wherein step b) further comprises the step of deleting a first token in the plurality of tokens.

10. The method of claim 8, wherein step b) further comprises the step of adding a first token to the plurality of tokens.

11. The method of claim 8, wherein step b) further comprises the step of editing a first token in the plurality of tokens.

12. The method of claim 8, wherein step b) further comprises the step of reordering a first token and a second token in the plurality of tokens.

13. The method of claim 8, wherein step b) further comprises the step of locking a first token in the plurality of tokens, wherein the first token appears in every domain name in the plurality of domain names.

14. A method, comprising the steps of:
a) receiving, by a server computer, a user search in a first data entry field on a webpage of a website from a user using a client;
b) tokenizing, by the server computer, the user search into a first token and a second token;
c) determining, by the server computer, a first plurality of keywords based on the first token and a second plurality of keywords based on the second token;
d) displaying, on the client to the user, by the server computer, the first token and the first plurality of keywords in a first list and the second token and the second plurality of keywords in a second list on the website, wherein the first list appears to the left of the second list on the website;
e) receiving, by the server computer, from the user a first indication that the user desires to reorder the first token and the second token;
f) displaying, on the client to the user, by the server computer, the second list and the first list on the website, wherein the second list appears to the left of the first list on the website;
g) receiving, by the server computer, from the user on the client, a first selection from the first list and a second selection from the second list;
h) creating, by the server computer, a domain name by concatenating the second selection, the first selection and a first domain name extension, in that order from left to right;
i) determining, by the server computer, whether the domain name is available for registration; and
j) if the domain name is available for registration:
I) displaying, by the server computer, the domain name on the website to the user on the client;
II) receiving, by the server computer, a response from the user on the client indicating the user desires to register the domain name; and
Ill) registering, by the server computer, to the user the domain name with an appropriate Registry.

15. The method of claim 14, wherein step b) further comprises the steps of:
I) parsing, by the server computer, the user search into a plurality of words;
II) finding, by the server computer, an entity in the plurality of words; and
III) tokenizing, by the server computer, the entity into either the first token or the second token.

16. The method of claim 14, further comprising the steps of:
k) receiving, by the server computer, from the user a second indication, wherein the second indication indicates that the user desires to delete the second token; and
l) displaying to the user on the client the first list while not displaying the second list on the website.

17. The method of claim 14, further comprising the steps of:
k) receiving, by the server computer, from the user a second indication, wherein the second indication indicates that the user desires to add a third token;
l) receiving, by the server computer, from the user the third token in a second data entry field;
m) determining, by the server computer, a third plurality of keywords based on the third token; and
n) displaying to the user the second list, the first list, and the third token and the third plurality of keywords in a third list on the website, in that order from left to right.

18. The method of claim 14, further comprising the steps of:
k) receiving, by the server computer, from the user a second indication, wherein the second indication indicates that the user desires to edit either the first token or the second token;
l) receiving, by the server computer, from the user an edited first token or an edited second token in a second data entry field;
m) determining, by the server computer, a third plurality of keywords based on the edited first token or the edited second token; and
n) displaying the edited first token or the edited second token and the third plurality of keywords in a third list.

19. The method of claim 14, further comprising the steps of:
k) creating, by a server computer, a plurality of domain names by concatenating different subcombinations and combinations of the first token and the first selection with the second token and the second selection with a one or more domain name extensions.

20. The method of claim 14, further comprising the steps of:
k) receiving, by the server computer, from the user a second indication, wherein the second indication indicates that the user desires to lock the first token or the second token;
l) creating, by the server computer, a plurality of domain names by concatenating different subcombinations and combinations of the first token and the first selection with the second token and the second selection with a one or more domain name extensions, wherein the locked token is in every domain name in the plurality of domain names;
m) determining, by the server computer, whether each domain name in the plurality of domain names is available for registration; and
n) displaying only domain names in the plurality of domain names that are available on the website to the user.
